(19) United States
(12) Patent Application Publication
(10) Pub. No.: US 2004/0106071 A1
(43) Pub. Date: Jun. 3, 2004

(54) Photoresist overcoating composition

(76) Inventors: Young Sun Hwang, Gyeongsangbuk-do (KR); Sam Young Kim, Gyeonggi-do (KR); Jae Chang Jung, Seoul (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/603,012

(22) Filed: Jun. 24, 2003

(30) Foreign Application Priority Data
Nov. 29, 2002 (KR) 2002-75289

(51) Int. Cl. G03C 5/00

(52) U.S. Cl. 430/322; 430/330

(57) ABSTRACT

Photoresist overcoating compositions are disclosed. More specifically, a photoresist overcoating composition comprising a compound represented by Formula 1 is disclosed that can reduce critical dimension difference between the center and the edge of a wafer in a patterning process.

### BACKGROUND

1. Technical Field

Photoresist overcoating compositions are disclosed. More specifically, photoresist overcoating compositions that comprise a compound represented by Formula 1 are disclosed that reduce a critical dimension (CD) difference between the center and the edge of a wafer in a patterning process using a chemically amplified photoresist resin.

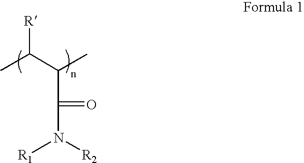

wherein

R′ is H or CH₃;

R₁ and R₂ individually are H or C₁-C₃ alkyl.

2. Description of the Related Art

In general, when patterns are formed using chemically amplified photoresist, a CD difference is generated between the center and the edge of wafers (see FIGS. 3a and 3b). The CD difference results primarily from acids generated from the chemically amplified resins during exposure. The acids are volatilized in a post-baking process, and re-deposited on the photoresist resin.

The CD in the wafer may be reduced by use of an exhaust system over hot plates during a post-baking process. As a result, exhaust systems are currently being studied.

The critical dimension becomes larger in the edge than in the center of the wafer, which decreases the yield of semiconductors device. In order to solve the problem, a greater exposure energy is applied to the center than to the edge of the wafer. However, this method is just a temporary solution.

Generally, acrylic acid or polyvinyl alcohol compounds are used for photoresist overcoating materials. However, it takes much time for these compounds to be dissolved in water due to their poor affinity to water, and they also have poor coating property. Therefore, a surfactant is required to be added when these compound are used as overcoating materials.

### SUMMARY OF THE DISCLOSURE

A photoresist overcoating composition is disclosed that can reduce a CD difference between the center and the edge of wafers in a patterning process using chemically amplified photoresist resins.

### BRIEF DESCRIPTION OF THE DRAWINGS

FIG. 1 is a NMR spectrum of poly(N,N-dimethylacrylamide).

FIG. 2a is a photograph illustrating a pattern on the center of a wafer in a patterning process using a disclosed photoresist overcoating composition.

FIG. 2b is a photograph illustrating a pattern on the edge of a wafer in a patterning process using a disclosed photoresist overcoating composition.

FIG. 3a is a photograph illustrating a pattern on the center of a wafer in a conventional patterning process.

FIG. 3b is a photograph illustrating a pattern on the edge of a wafer in a conventional patterning process.

### DETAILED DESCRIPTION OF THE PRESENTLY PREFERRED EMBODIMENTS

Photoresist overcoating compositions are disclosed which comprise a solvent and compound represented by Formula 1. The solvent is distilled water.

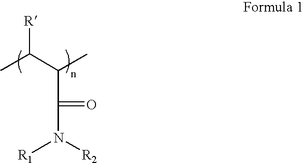

wherein

R′ is H or CH₃;

R₁ and R₂ individually are H or C₁-C₃ alkyl.

It is preferable that the compound of Formula 1 is poly(N,N-dimethylacrylamide), which is R′ is H, and both R₁ and R₂ are methyl groups.

Preferably, the above compound of Formula 1 is present in an amount ranging from 1 to 30 wt % to the solvent. When the compound is used in the amount less than 1 wt %, the coating thickness of overcoating film is too thin to serve as the overcoating material. Although the compound can serve as the overcoating material when the compound is used in the amount more than 30 wt %, the compound is preferably used in the amount less than 30 wt % because of cost saving.

A process for forming a photoresist pattern comprises:

(a) coating a photoresist composition on an underlying layer to form a photoresist film;

(b) coating the photoresist overcoating composition described above on the photoresist film to form an overcoating film;

(c) exposing the resultant structure;

(d) baking the resultant structure; and

(e) developing the resultant structure.

The photoresist composition preferably includes a chemically amplified photoresist resin. Exemplary light sources used in exposing step include ArF (193 nm), KrF (248 nm), F₂(157 nm), EUV (13 nm), E-beam, X-ray or ion beam.

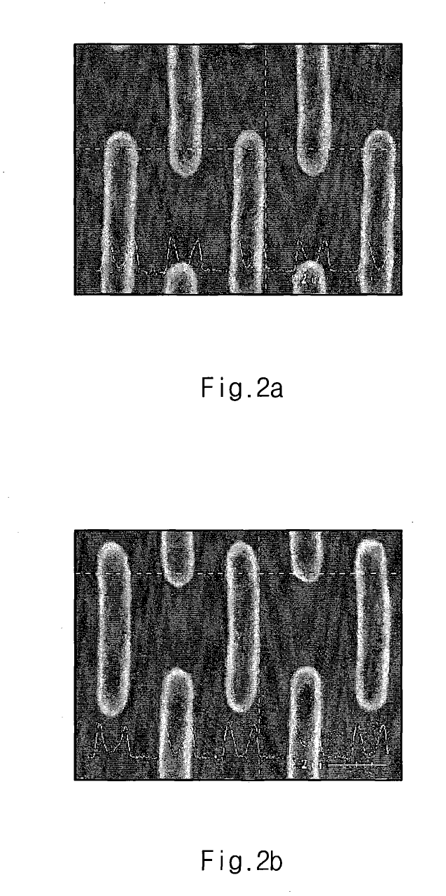

As described above, the CD results primarily from acids generated from the patterning process using the chemically amplified photoresist resins during exposure. The acids are volatilized in a post-baking process, and re-deposited on the photoresist resin. However, the overcoating material including the compound of Formula 1 contains an amide group, and when coated on the photoresist resin, a CD difference barely occurs because the compound of Formula 1 absorbs the volatilized acids in the baking process (see FIGS. 2a and 2b).

Moreover, the compound of Formula 1 has excellent solubility in water and sufficient affinity to organics, while the conventional overcoating materials such as acrylic acid or polyvinyl alcohol have low solubility in water and poor coating property. Therefore, the disclosed overcoating composition can be prepared without surfactant.

The disclosed photoresist overcoating composition will be described in more detail by referring to examples below, which are not intended to be limiting.

### PREPARATION EXAMPLE

### Synthesis of Poly(N,N-dimethylacrylamide)

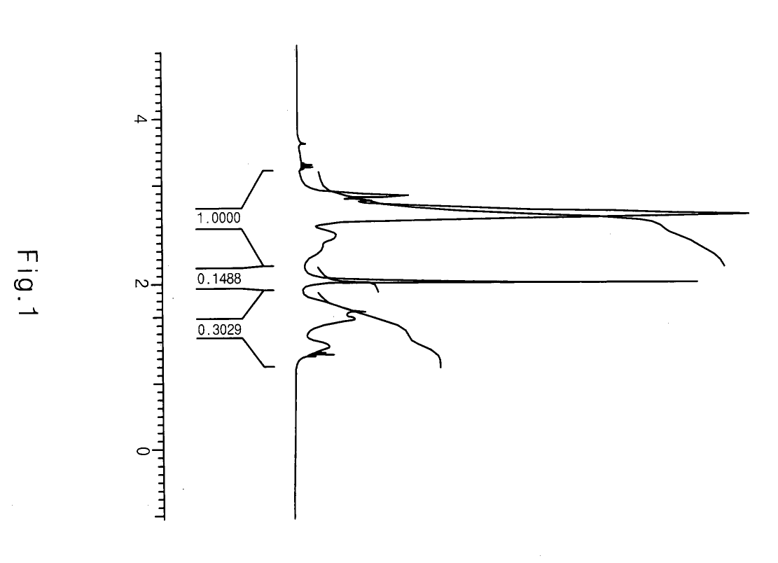

To tetrahydrofuran solvent (30 g) was added N,N-dimethylacrylamide (10 g) and 2,2-azobisisobutylronitrile (AIBN) (0.5 g), and the mixture was reacted at a temperature of 66° C. for 9 hours. Thereafter, the resulting mixture was precipitated in ethyleter, and dehydrated in vacuum, thereby obtaining pure poly(N,N-dimethylacrylamide) (molecular weight 12700, yield 88%) (see FIG. 1).

### EXAMPLE 1

### Preparation of Photoresist Overcoating Composition

To distilled water (50 g) was added the poly(N,N-dimethylacrylamide) (1 g) obtained from Preparation Example. The resulting solution was filtered through 0.2 μm filter, thereby obtaining an overcoating composition.

### EXAMPLE 2

### Formation of Photoresist Pattern

HOF-J008 photoresist (commercial product) of JSR Co. was coated on a silicon wafer to form a photoresist film, and then baked at a temperature of 100° C. for 90 seconds. The overcoating composition obtained from Example 1 was coated on the photoresist film to form an overcoating film, and then re-baked at a temperature of 70° C. for 90 seconds. After baking the wafer was exposed to light using a KrF laser exposer (ASML Co.), and then post-baked at a temperature of 100° C. for 90 seconds. When the post-baking was completed, the wafer was developed in 2.38 wt % aqueous TMAH solution to obtain 120 nm island patterns. As shown in FIGS. 2a and 2b, small CD difference of about 4 nm was shown between CD (123 nm) of the center and CD (127 nm) of the edge of the wafer.

### COMPARATIVE EXAMPLE

### Formation of Photoresist Pattern

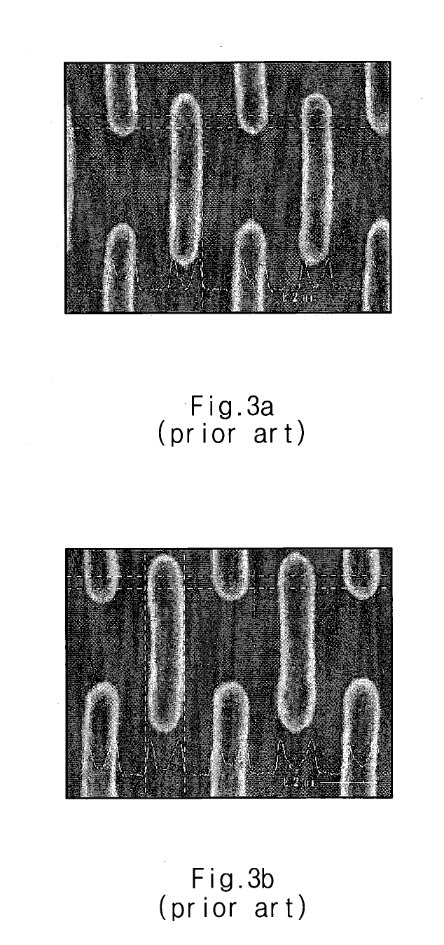

HOF-J008 photoresist (commercial product) of JSR Co. was coated on a silicon wafer to form a photoresist film, and then baked at a temperature of 100° C. for 90 seconds. After the baking, the wafer was exposed to light using a KrF laser exposer (ASML Co.), and then post-baked at a temperature of 100° C. for 90 seconds. When the post-baking was completed wafer was developed in 2.38 wt % aqueous TMAH solution to obtain 120 nm island patterns. As shown in FIGS. 3a and 3b, large CD difference of about 17 nm was shown between CD (122 nm) of the center and CD (139 min) of the edge of the wafer.

As shown in the results of Example 2 and Comparative Example, the CD difference was remarkably reduced by using the disclosed overcoating composition.

As discussed earlier, since the disclosed photoresist overcoating composition comprising the compound of Formula 1 contains an amide group, the disclosed composition absorbs the volatilized acids in a post-baking process.

As a result, the disclosed composition effectively reduce the CD difference between the center and the edge of wafers.

What is claimed is:

1. A photoresist overcoating composition comprising:
a solvent; and
a compound represented by Formula 1: 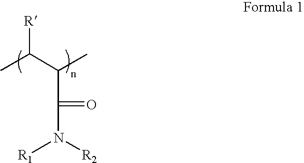
wherein
R′ is H or CH₃;
R₁ and R₂ individually are H or C₁-C₃ alkyl.

2. The photoresist overcoating composition according to claim 1, wherein the compound of Formula 1 is poly(N,N-dimethylacrylamide).

3. The photoresist overcoating composition according to claim 1, wherein the solvent is distilled water.

4. The photoresist overcoating composition according to claim 1, wherein the compound of Formula 1 is present in an amount ranging from 1 to 30 wt % to the solvent.

5. A process for forming a photoresist pattern, comprises:
(a) coating a photoresist composition on an underlying layer to form a photoresist film;
(b) coating the photoresist overcoating composition of claim 1 on the photoresist film to form an overcoating film;
(c) exposing the resultant structure;
(d) baking the resultant structure; and
(e) developing the resultant structure.

6. The process according to claim 5, wherein the photoresist composition includes a chemically amplified photoresist resin.

7. The process according to claim 5, wherein the light source of the exposing step is selected from the group consisting of ArF (193 nm), KrF (248 nm), F₂ (157 nm), EUV (13 nm), E-beam, X-ray and ion beam.
